(19) United States
(12) Patent Application Publication
(10) Pub. No.: US 2025/0391591 A1
(43) Pub. Date: Dec. 25, 2025

(54) MULTI-PURPOSE HOLLOW CORE INSULATOR FOR COMPONENTS IN A HIGH VOLTAGE POWER LINE

(71) Applicant: Rajkumar Padmawar, Victoria (CA)

(72) Inventor: Rajkumar Padmawar, Victoria (CA)

(21) Appl. No.: 18/754,023

(22) Filed: Jun. 25, 2024

(51) Int. Cl. H01B 17/58; H01H 33/662

(52) U.S. Cl. CPC H01B 17/58; H01H 33/662

(57) ABSTRACT

A hollow core insulator is provided for housing an electronics module for use in power transmission and distribution lines, the hollow core insulator comprising: a fibre-reinforced plastic (FRP) core which includes a first flange, a second flange and a body therebetween, the insulating core defining a bore, wherein the flanges and body are integral and the first flange and the second flange each include a face and a plurality of threaded apertures extending into the face; and a silicone mold which encases the body and includes a series of sheds extending outward from the body, wherein at least one shed includes a perimeter lip.

### FIELD

The present technology is directed to an insulator with a hollow core for planting sensors or switches for power transmission and distribution systems. More specifically, it is an insulator for use with the Internet of Things, that is configured to accept a vacuum circuit breaker or sensors or both, includes sheds, and does not require metal crimping and therefore reduces or eliminates arcing.

### BACKGROUND OF THE INVENTION

Power transmission and distribution systems include switching systems to ensure safe operation of the systems. With increasing environmental threats relating to climate change, for example, forest fires, the importance of autonomous switching has increased. One such switching system is based on switching in a vacuum. Switching in vacuum achieves faster current interruption than existing alternating current (AC) switching technologies. A vacuum circuit breaker (VCB) that uses an electromagnetic repulsion actuator is able to achieve a theoretical limit of AC interruption, which can interrupt a short-circuit current in the first half-cycle of a fault current, compared to the more common three cycles for existing current switching technologies. This can thus greatly enhance the transient stability of power networks in the presence of short-circuit faults, especially for ultra- and extra-high-voltage power transmission lines. While this technology is almost 100 years old, there are still deficiencies in VCB technology. One serious deficiency is a lack of adequate shielding from arcing. It is an object of the present technology to overcome this deficiency through the use of a hollow insulator for the vacuum circuit breaker.

United States Patent Application Publication No. 20220314525 discloses a method for producing a hollow electrical insulator having the following steps: —providing a core, —winding first wound layers of a first fiber element onto the core, —winding second wound layers of a second fiber element onto an end region of the core, wherein—the first wound layers comprise turns of the first fiber element which include a first winding angle with a main direction of extension (R) of the core, —the second wound layers omprise turns of the second fiber element which include a second winding angle (α2) with the main direction of extension (R) of the core, which second winding angle is larger than the first winding angle, and—an inner region of the core remains free of second wound layers. The invention also relates to a hollow electrical insulator and the use thereof. This electrical insulator requires a flange for attachment in a transformer. Shielding is preferably silicone.

United States Patent Application Publication No. 20200343024 discloses a hollow insulator for high electric voltages has an insulating tube and a covering of the insulating tube made from a fiber-reinforced plastic. The covering is placed on an outer surface of the insulating tube. There is also described a method for producing the type of hollow insulator. The electrical insulator requires flanges.

WO/2009/109216 discloses an electrical hollow core insulator wherein the wall of said electrical insulator is made from a fiber reinforced organic polymer composite system comprising a hardened or cured electrically insulating matrix resin composition and a reinforcing fiber, said wall further comprising an outer layer and an inner layer, both layers together forming said wall as integral parts, wherein (i) the outer layer of the wall is reinforced with a corrosion sensitive fiber; (ii) the inner layer of the wall is reinforced with a corrosion resistant fiber, and (iii) the hardened or cured matrix resin composition has a glass transition temperature (Tg) within the range of 1600° C. to 250° C.; and electrical articles comprising said electrical hollow core insulator.

CN105679596 discloses a super-high-voltage vacuum insulation device. A vacuum chamber is divided into a first vacuum chamber and a second vacuum chamber; one end of the first vacuum chamber is communicated with one end of the second vacuum chamber; the other end of the first vacuum chamber is provided with a grounding end interface; the other end of the second vacuum chamber is provided with a high-voltage end interface; a grounding wire is connected into the first vacuum chamber; a high-voltage wire is connected into the second vacuum chamber; the first vacuum chamber, the second vacuum chamber, the grounding end interface, the high-voltage end interface and the high-voltage wire are all made of an insulation material; and in the second vacuum chamber, the high-voltage wire is provided with an insulation coating corresponding to the inner wall of the second vacuum chamber. Thus, high voltage can be effectively prevented from generating electric arcs in the insulation device, and the insulation performance and service life of the insulation device can be effectively ensured.

U.S. Pat. No. 3,848,081 discloses a hollow high-voltage electric insulator that includes a shell made of electrically insulating material and which is symmetrical about its axis and formed by a wall having a thickness that is small as compared to the shell's cross-sectional extent. This shell is formed with two sections of substantially different cross-sectional extents with the section having the smaller of these extents partially projecting into the other of the two sections for a portion of the latter's length and by a reversely curving wall portion radially connecting therewith. The shell's wall thickness is substantially the same throughout including the two sections and the portion of the shell which interconnects these two sections. Both sections may be substantially cylindrical. The insulator may be used to either support or drive an electrically conductive member carrying a high-voltage electric current. This would require metal flanges.

WIPO Patent Application Publication No. WO/2000/034962 discloses a hollow insulator for high voltages. Said hollow insulator is provided with an insulating body with a hollow support element made of a thermoset and is provided with a potential control means. The potential control means is encapsulated with the thermoset of the support element and is at least partially coiled by fibres. A blank mould of the support element is formed out of the potential control means and the thermoplast which is still soft according to the filament winding method in order to produce said hollow insulator. The blank mould is heated and hardened. The hollow insulator can be produced simply and inexpensively. The constructive concept of the potential control means is no longer dependent on mechanical conditions or on conditions necessary for assembly. There are sheds, but there is no core. Metal flanges are required.

What is needed is an insulator that can reduce or eliminate arcing across a high power line switch. It would be preferable it the insulator included a core that defines a bore, the core including integral flanges. It would be preferable if the bore was sized to retain a vacuum bottle or at least one sensor or both. It would be preferable if the flanges included threaded apertures for accepting metal end plates, but aside from that, were a non-conducting polymeric material. It would be further preferable if the body of the core was enveloped in a silicone molding. It would be still further preferable if the silicone molding included sheds with a drip bead. It would be further preferable if a combination of a vacuum circuit breaker and the hollow core insulator was provided.

### SUMMARY OF THE INVENTION

Provided is an insulator that reduces or eliminates arcing. It includes a core that defines a bore, the core including integral flanges. The bore is sized to retain at least one sensor or a vacuum bottle or both. The flanges include threaded apertures for accepting metal end plates, but aside from that, are a non-conducting polymeric material. The body of the core is enveloped in a silicone molding. The silicone molding included sheds with a drip bead to both increase water shedding and to increase the effective distance between the flanges and the end plates. A combination of a sensor, a vacuum circuit breaker and the hollow core insulator is also provided, the hollow core housing the vacuum circuit breaker. The combination allows for autonomous switching in response to a given sensed condition.

In one embodiment, a hollow core insulator is provided for housing an electronics module for use in power transmission and distribution lines, the hollow core insulator comprising: an insulating core which includes a first flange, a second flange and a body therebetween, the insulating core defining a bore, wherein the flanges and body are integral; and a silicone mold which encases the body and includes a plurality of sheds extending outward from the body.

In the hollow core insulator, the insulating core may comprise fibre-reinforced plastic.

In the hollow core insulator, the first flange and the second flange may each include a face and a plurality of threaded apertures extending into the face.

In the hollow core insulator, there may be a series of sheds, the series of sheds alternating between a shed with a large diameter and a shed with a small diameter.

In the hollow core insulator, the shed with the larger diameter may include the perimeter lip.

In the hollow core insulator, the hollow core insulator imay be a crimpless hollow core insulator.

In another embodiment, a combination is provided for use in power transmission and distribution lines, the combination comprising:
a hollow core insulator comprising: an insulating core which includes a first flange, a second flange and a body therebetween, the insulating core defining a bore, wherein the flanges and body are integral; and a silicone mold which encases the body and includes a plurality of sheds extending outward from the body; and
an electronics module which is housed in the bore of the insulating core.

In the combination, the electronics module includes a circuit breaker.

The combination the electronics module may further include at least one sensor in electrical communication with the circuit breaker.

In the combination, the sensor may be an electrical sensor or an environmental sensor.

In the combination, the sensor may be an electrical sensor.

In the combination, the circuit breaker may be a vacuum circuit breaker.

In the combination, the insulating core may comprise fibre-reinforced plastic.

In the combination, the first flange and the second flange may each include

a face and a plurality of threaded apertures extending into the face.

In the combination, at least one shed may include a perimeter lip.

In the combination, there may be a series of sheds, the series of sheds alternating between a shed with a large diameter and a shed with a small diameter.

In the combination, the shed with the larger diameter may include the perimeter lip.

In the combination, the hollow core insulator may be a crimpless hollow core insulator.

In another embodiment, a hollow core insulator is provided for housing an electronics module for use in power transmission and distribution lines, the hollow core insulator comprising: a fibre-reinforced plastic (FRP) core which includes a first flange, a second flange and a body therebetween, the insulating core defining a bore, wherein the flanges and body are integral and the first flange and the second flange each include a face and a plurality of threaded apertures extending into the face; and a silicone mold which encases the body and includes a series of sheds extending outward from the body, wherein at least one shed includes a perimeter lip.

The hollow core insulator may further comprise the electronics module which is housed in the bore.

In the hollow core insulator, the electronics module may include a vacuum circuit breaker.

### BRIEF DESCRIPTION OF DRAWINGS

FIG. 1A is a longitudinal sectional view of the hollow core insulator of the present technology; and FIG. 1B is a longitudinal sectional view of an alternative embodiment hollow core insulator.

FIG. 2 is an exploded end view of the hollow core insulator of FIG. 1, with fasteners and metal plates.

FIG. 3 is a longitudinal sectional view of a combination of the present technology.

FIG. 4 is an exploded view of an alternative embodiment combination of the present technology.

### DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

### Definitions

Effective distance—in the context of the present technology, the effective distance is the distance between the two flanges as defined by the sheds, which increase the absolute distance between the two flanges, the absolute distance being the length of the body of the core.

### DETAILED DESCRIPTION OF THE INVENTION

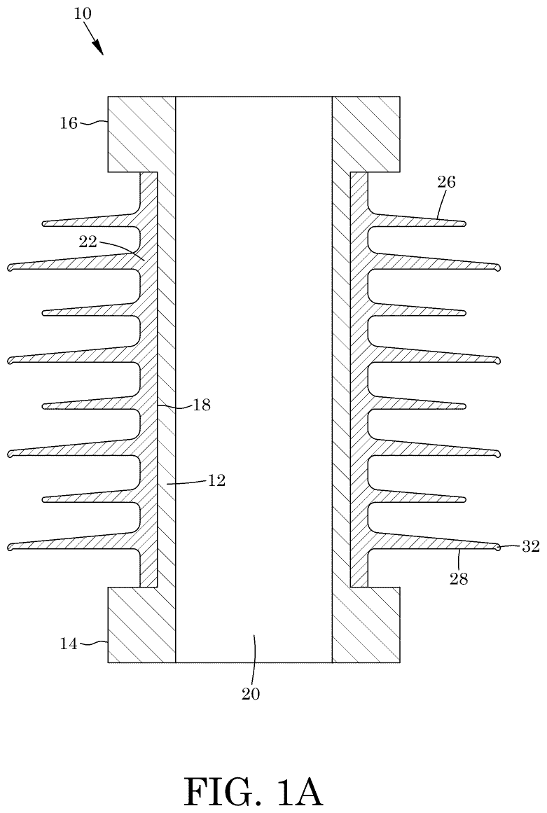

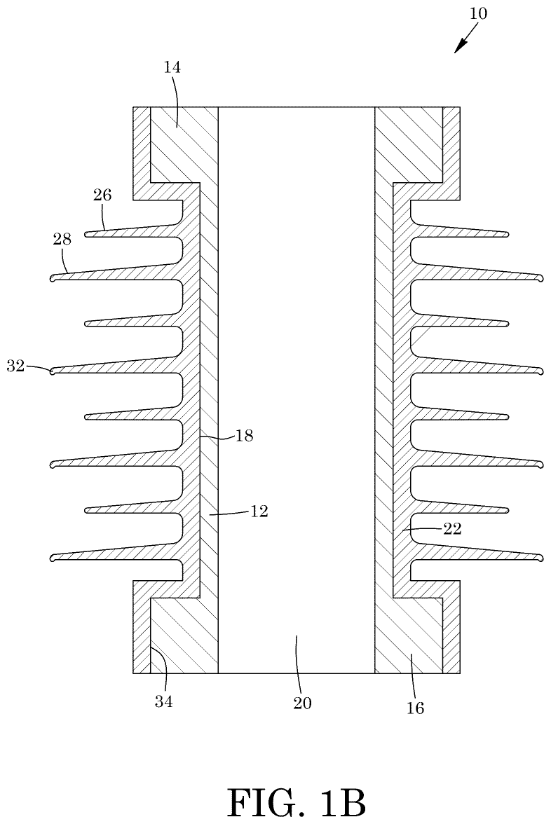

As shown in FIG. 1A, a hollow core insulator, generally referred to as 10 includes a core 12, with a first flange 14, a second flange 16 and a body 18. The core 12 defines a bore 20. The bore 20 is sized to accept an electronics module, more specifically, the body section of the bore 20 is sized to accept at least one electronics module, which includes one or more of a sensor, a switching mechanism or other electronic modules for use with, for example, the Internet of Things. The core 12 is composed of fibre-reinforced plastic (FRP). Without being bound to theory, the dielectric properties of FRP make it an excellent insulator. The electronics module

The body 18 of the core 12 is encased in a silicone mold 22, which includes sheds extending outward. There are smaller diameter sheds 26 and larger diameter sheds 28. The larger diameter sheds 28 extend outward beyond the perimeter 30 of the smaller diameter sheds 26. The larger diameter sheds 28 terminate in a perimeter lip 32. The perimeter lip 32 functions as a rain guard or drip bead that sheds water and pollution. This allows the hydrophobic property of the surface material to be minimally impacted. It also reduces or eliminates settlement of any protein or spray-borne algae that might encourage algae growth on the surface. Without being bound to theory, shedding of water and pollution reduces the probability of arcing. It also increases the effective distance, as defined above, between the first flange 14 and the second flange 16. Without being bound to theory, the larger the effective distance, the less likely there will be arcing in the event of a power shutdown. In an alternative embodiment, shown in FIG. 1B, the silicone mold 22 covers the sidewall 34 of the flanges 14, 16 as well as the body 18.

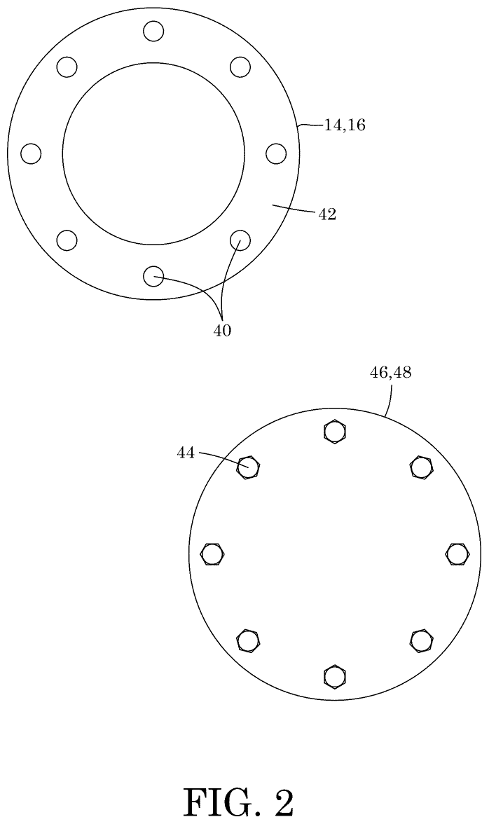

As shown in FIG. 2, each flange 14,16 includes threaded apertures 40 which extend around and into the face 42 of each flange 14,16. These are to accept fasteners such as bolts 44 that retain a plate 46, 48 on each flange 14,16. As the flanges 14, 16 are integral and are composed almost entirely of FRP, they are crimpless and hence, no metal, other than the threaded apertures, is needed. Without being bound to theory, the crimpless design further increases the electrical insulation of the hollow core insulator 10 and decreases the potential for arcing.

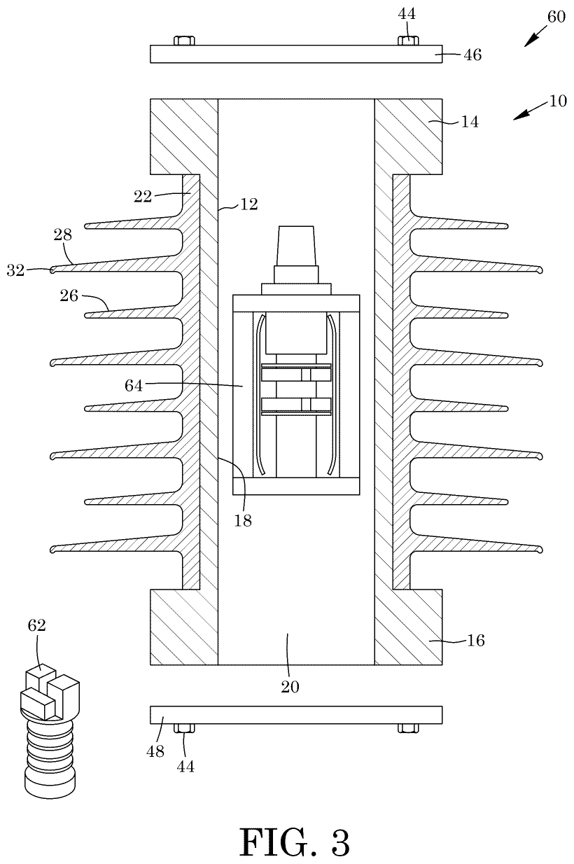

As shown in FIG. 3, an exemplary combination, generally referred to as 60 includes the hollow core insulator 10, the plates 46, 48, the bolts 44, at least one sensor 62 and a vacuum circuit breaker 64. The combination 60 allows for autonomous switching the power in the power line on and off.

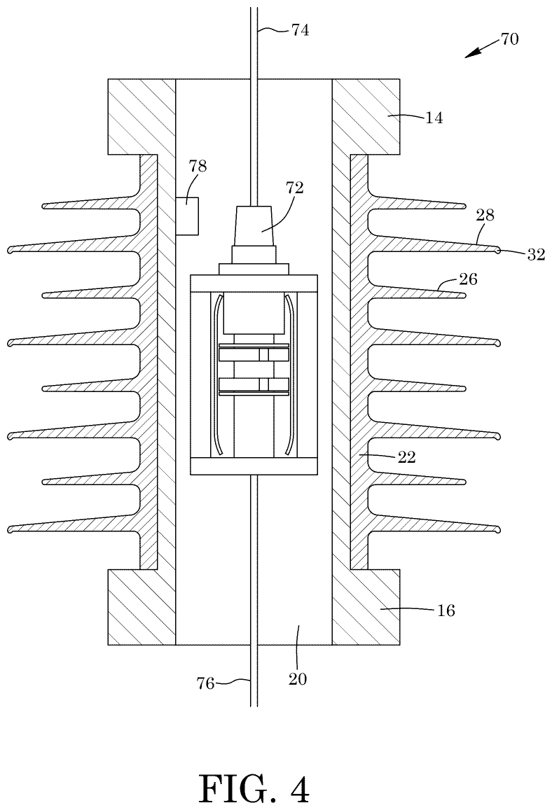

As shown in FIG. 4, an alternative embodiment combination, generally referred to as 70, includes the hollow core insulator 10, a switching mechanism 72 which is housed in the bore 20 of the hollow core insulator 10, connectors 74, 76 that are connected to the switching mechanism 72 and to the high power transmission or distribution line. At least one sensor 78 may be housed within the bore 20. It is in communication with the switching mechanism 72. The switching mechanism 72 may be, for example but not limited to a vacuum circuit breaker, an oil circuit breaker, an air circuit breaker, a carbon dioxide circuit breaker, or a sulfur hexafluoride circuit breaker.

In use, the electronics module is housed within the bore 20 of the hollow core insulator 10. Metal plates 46, 48 are affixed to the face 42 of each flange 14, 16, with bolts 44 that mate with the threaded apertures 40. The metal plates 46, 48 abutt the circuit breaker at each end to provide an electrical connection, or are connected to the circuit breaker via a connector. A voltage sensor 62, 78 is in electrical communication with the high power transmission or distribution line and with the circuit breaker. In the event of a power anomaly, the circuit breaker will switch off and the power supply will be interrupted. As a result of the hollow core insulator 10, arcing will be minimized or eliminated.

In an alternative embodiment, the sensor may be an environmental sensor such as a heat sensor, a particulate matter sensor such as a smoke detector, a gas sensor such as a carbon monoxide sensor or a volative organic compound sensor and the like.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. A hollow core insulator for housing an electronics module for use in power transmission and distribution lines, the hollow core insulator comprising: an insulating core which includes a first flange, a second flange and a body therebetween, the insulating core defining a bore, wherein the flanges and body are integral; and a silicone mold which encases the body and includes a plurality of sheds extending outward from the body.

2. The hollow core insulator of claim 1, wherein the insulating core comprises fibre-reinforced plastic.

3. The hollow core insulator of claim 2, wherein the first flange and the second flange each include a face and a plurality of threaded apertures extending into the face.

4. The hollow core insulator of claim 3, wherein at least one shed includes a perimeter lip.

5. The hollow core insulator of claim 4, wherein the hollow core insulator is a crimpless hollow core insulator.

6. A combination for use in power transmission and distribution lines, the combination comprising:
a hollow core insulator comprising: an insulating core which includes a first flange, a second flange and a body therebetween, the insulating core defining a bore, wherein the flanges and body are integral; and a silicone mold which encases the body and includes a plurality of sheds extending outward from the body; and
an electronics module which is housed in the bore of the insulating core.

7. The combination of claim 6, wherein the electronics module includes a circuit breaker.

8. The combination of claim 7, wherein the electronics module includes at least one sensor in electrical communication with the circuit breaker.

9. The combination of claim 8, wherein the sensor is an electrical sensor or an environmental sensor.

10. The combination of claim 8, wherein the sensor is an electrical sensor.

11. The combination of claim 8, wherein the circuit breaker is a vacuum circuit breaker.

12. The combination of claim 11, wherein the insulating core comprises fibre-reinforced plastic.

13. The combination of claim 12, wherein the first flange and the second flange each include a face and a plurality of threaded apertures extending into the face.

14. The combination of claim 13, wherein at least one shed includes a perimeter lip.

15. The combination of claim 14, wherein there is a series of sheds, the series of sheds alternating between a shed with a large diameter and a shed with a small diameter.

16. The combination of claim 15, wherein the shed with the larger diameter includes the perimeter lip.

17. The combination of claim 16, wherein the hollow core insulator is a crimpless hollow core insulator.

18. A hollow core insulator for housing an electronics module for use in power transmission and distribution lines, the hollow core insulator comprising: a fibre-reinforced plastic (FRP) core which includes a first flange, a second flange and a body therebetween, the insulating core defining a bore, wherein the flanges and body are integral and the first flange and the second flange each include a face and a plurality of threaded apertures extending into the face; and a silicone mold which encases the body and includes a series of sheds extending outward from the body, wherein at least one shed includes a perimeter lip.

19. The hollow core insulator of claim 18 further comprising the electronics module which is housed in the bore.

20. The hollow core insulator of claim 19, wherein the electronics module includes a vacuum circuit breaker.
